(19) United States
(12) Patent Application Publication
(10) Pub. No.: US 2026/0269132 A1
(43) Pub. Date: Sep. 10, 2026

(54) MULTILAYER ELECTRONIC COMPONENT

(71) Applicant: SAMSUNG ELECTRO-MECHANICS CO., LTD., Suwon-si (KR)

(72) Inventors: Ka Young KIM, Suwon-si (KR); Byung Hun LEE, Suwon-si (KR); Sang Won CHOI, Suwon-si (KR)

(73) Assignee: SAMSUNG ELECTRO-MECHANICS CO., LTD., Suwon-si (KR)

(21) Appl. No.: 19/437,670

(22) Filed: Dec. 31, 2025

(30) Foreign Application Priority Data
Mar. 4, 2025 (KR) 10-2025-0027326

(51) Int. Cl. H01G 4/30; H01G 4/012; H01G 4/232

(52) U.S. Cl. CPC H01G 4/30; H01G 4/012; H01G 4/232

(57) ABSTRACT

A multilayer electronic component includes a body including a capacitance formation portion including a dielectric layer, an internal electrode layer and a floating electrode layer. The internal electrode layer is a first internal electrode connected to the first external electrode, and a second internal electrode connected to the second external electrode and spaced apart from the first internal electrode. The floating electrode layer includes a third internal electrode. The third internal electrode has a main portion overlapping the first and second internal electrodes in the thickness direction, and a connecting portion not overlapping the first and second internal electrodes in the thickness direction. A ratio (FCW/FMW) of a size (FCW) of the connecting portion in the width direction to a size (FMW) of the main portion in the width direction satisfies 1/4≤FCW/FMW≤1/2.

### CROSS-REFERENCE TO RELATED APPLICATION(S)

This application claims benefit of priority to Korean Patent Application No. 10-2025-0027326 filed on Mar. 4, 2025 in the Korean Intellectual Property Office, the disclosure of which is incorporated herein by reference in its entirety.

### TECHNICAL FIELD

The present disclosure relates to a multilayer electronic component.

### BACKGROUND ART

A multilayer ceramic capacitor (MLCC), a multilayer electronic component, is a chip-type condenser, mounted on the printed circuit boards of various types of electronic product, such as image display devices including a liquid crystal display (LCD) and a plasma display panel (PDP), computers, smartphones and mobile phones, and may be configured to charge or discharge electricity therein or therefrom.

Such multilayer ceramic capacitors may be used as a component in various electronic devices due to having a small size, ensuring high capacitance and being easily mounted. As various electronic devices, such as computers and mobile devices, or the like, become smaller and have higher output, demand for miniaturization and high capacitance in multilayer ceramic capacitors is increasing.

In addition, with the recent surge in demand for MLCCs, the development of MLCCs having excellent reliability, even in high-voltage environments, is becoming increasingly important. In a high-voltage environment, a dielectric layer of an MLCC must be thick while still providing excellent capacitance, and a design that can prevent cracks from occurring due to internal electrostrictive expansion is required. To address this issue, a method is being applied to change the design of some structures of the internal electrodes to a floating electrode structure that is not connected to the external electrodes, however, in this case, side effects such as a decrease in capacitance characteristics may occur, so it is necessary to design an optimal structure.

### DISCLOSURE OF THE INVENTION

### Technical Problem

One of many problems to be solved by the present disclosure is to provide a multilayer electronic component in which stress due to electrostrictive expansion is distributed.

One of many problems to be solved by the present disclosure is to provide a multilayer electronic component having improved electrostriction resistance due to additional securing of a margin region outside of the internal electrode.

One of many problems to be solved by the present disclosure is to provide a multilayer electronic component having improved structural defects.

One of many problems to be solved by the present disclosure is to provide a multilayer electronic component having improved breakdown voltage (BDV) characteristics without degrading capacitance characteristics.

However, the many problems to be solved by the present disclosure are not limited to the above and will be more easily understood in the process of describing specific embodiments of the present disclosure.

### Solution to Problem

A multilayer electronic component according to an embodiment of the present disclosure may comprise: a body including a capacitance formation portion including a dielectric layer, and an internal electrode layer and a floating electrode layer alternately disposed in a thickness direction with the dielectric layer interposed therebetween, first and second surfaces facing each other in the thickness direction, third and fourth surfaces connected to the first and second surfaces and facing each other in a length direction, and fifth and sixth surfaces connected to the first to fourth surfaces and facing each other in a width direction; and first and second external electrodes respectively disposed on the third and fourth surfaces, wherein the internal electrode layer includes a first internal electrode exposed to the third surface and connected to the first external electrode, and a second internal electrode spaced apart from the first internal electrode and exposed to the fourth surface and connected to the second external electrode, wherein the floating electrode layer includes a third internal electrode spaced apart from the first and second external electrodes, and the third internal electrode includes a main portion overlapping the first and second internal electrodes in the thickness direction, and a connecting portion not overlapping the first and second internal electrodes in the thickness direction, wherein a ratio (FCW/FMW) of a size (FCW) of the connecting portion in the width direction to a size (FMW) of the main portion in the width direction satisfies 1/4≤FCW/FMW≤1/2.

### Advantageous Effects of Invention

One of many effects of the present disclosure is that stress caused by electrostrictive expansion of a multilayer electronic component may be dispersed.

One of many effects of the present disclosure is that electrostriction resistance of a multilayer electronic component may be improved.

One of the many effects of the present disclosure is that the breakdown voltage (BDV) may be improved without deteriorating the capacitance characteristics of a multilayer electronic component.

However, the various advantageous effects of the present disclosure are not limited to the above and will be more easily understood in the process of describing specific embodiments of the present disclosure.

### BRIEF DESCRIPTION OF THE DRAWINGS

FIG. 1 schematically illustrates a perspective view of a multilayer electronic component according to an embodiment of the present disclosure.

FIG. 2 schematically illustrates a cross-sectional view taken along line I-I′ of FIG. 1 showing an internal electrode layer and a floating electrode layer.

FIG. 3 schematically illustrates a cross-sectional view taken along line II-II′ of FIG. 1 showing an internal electrode layer and a floating electrode layer.

FIGS. 4A and 4B schematically illustrate the structure of the internal electrode layer and the floating electrode layer of FIGS. 2-3.

### DESCRIPTION OF REFERENCE CHARACTERS

Hereinafter, embodiments of the present disclosure will be described with reference to specific embodiments and the accompanying drawings. However, embodiments of the present disclosure may be modified to have various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

In the drawings, a Z-direction may be defined as a thickness direction or a first direction, an X-direction as a length direction or a second direction, and a Y-direction as a width direction or a third direction. Additionally, a stacking direction may be a thickness direction or a width direction.

In addition, in the present disclosure, a thickness may refer to a size in the first direction, a length may refer to a size in the second direction, and a width may refer to a size in the third direction.

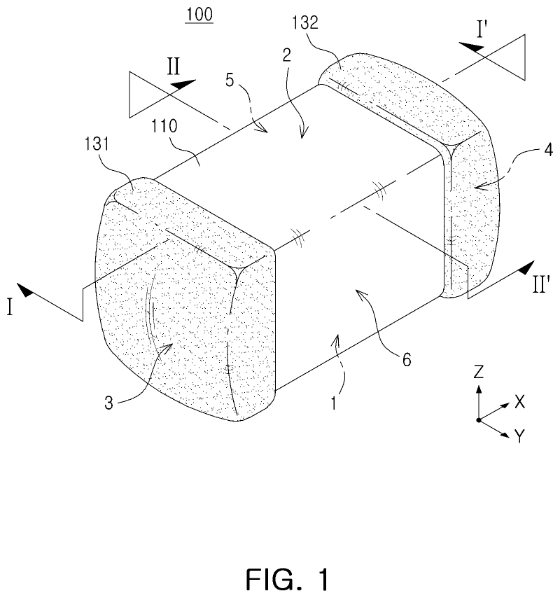

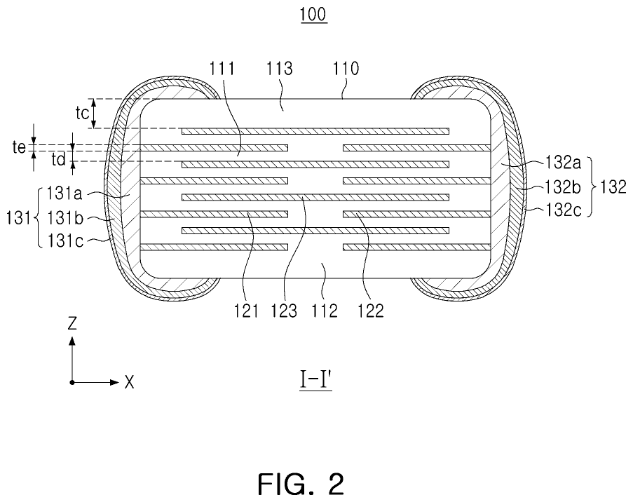

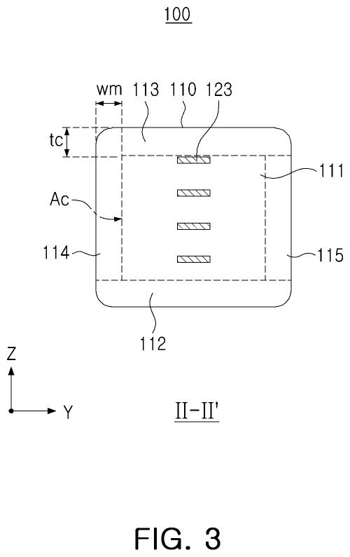

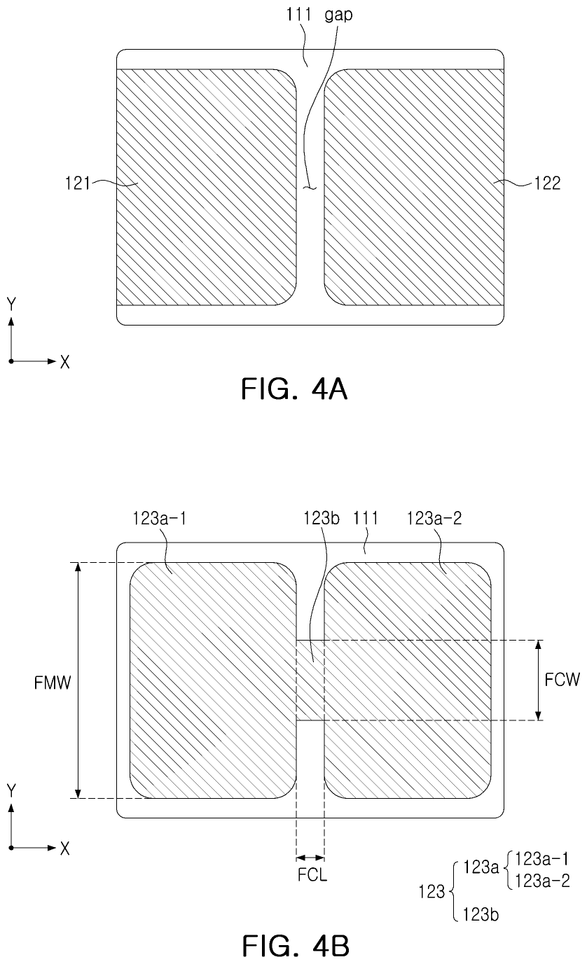

Hereinafter, a multilayer electronic component according to an embodiment of the present disclosure will be described in detail with reference to FIGS. 1 to 4B. As an example of a multilayer electronic component, a multilayer ceramic capacitor is described, but the present disclosure may also be applied to various electronic products using a dielectric composition, such as inductors, piezoelectric elements, varistors, or thermistors.

A multilayer electronic component 100 according to an embodiment of the present disclosure may comprise a body 110. The body 110 may include a capacitance formation portion Ac including a dielectric layer 111, and internal electrode layers and floating electrode layers alternately disposed in the thickness direction with the dielectric layer 111 interposed therebetween. The body 110 may include first and second surfaces 1 and 2 facing each other in the thickness direction, third and fourth surfaces 3 and 4 connected to the first and second surfaces 1 and 2, and facing each other in the length direction, and fifth and sixth surfaces 5 and 6 connected to the first to fourth surfaces 1, 2, 3 and 4, and facing each other in the width direction. The body 110 may include first and second external electrodes 131 and 132 respectively disposed on the third and fourth surfaces 3 and 4. The internal electrode layer may include a first internal electrode 121 exposed to the third surface 3 and connected to the first external electrode 131, and a second internal electrode 122 spaced apart from the first internal electrode 121, exposed to the fourth surface 4, and connected to the second external electrode 132. The floating electrode layer includes a third internal electrode 123 that is spaced apart from the external electrodes 131 and 132. The third internal electrode 123 has a main portion 123a overlapping with the internal electrodes 121 and 122 in the thickness direction, and a connection portion 123b not overlapping with the internal electrodes 121 and 122 in the thickness direction. A ratio FCW/FMW of a size FCW of the connection portion 123b in the width direction to a size FMW of the main portion 123a in the width direction may satisfy 1/4≤FCW/FMW≤1/2.

The body 110 may have internal electrode layers (e.g. the internal electrodes 121 and 122) and floating electrode layers (e.g. the third internal electrode 123) alternately stacked with a dielectric layer 111 in therebetween.

More specifically, the body 110 may include a capacitance formation portion Ac forming a capacitance, including an internal electrode layer (e.g. the internal electrodes 121 and 122) and a floating electrode layer (e.g. the third internal electrode 123) that are disposed alternately to face each other with a dielectric layer 111 interposed therebetween, and disposed inside the body 110.

There is no particular limitation on the specific shape of the body 110, but as illustrated, the body 110 may have a hexahedral shape or a shape similar thereto. Due to shrinkage of the ceramic particles included in the body 110 during a sintering process, the body 110 may not have a hexahedral shape with entirely straight lines but may have a substantially hexahedral shape.

The body 110 may have first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction.

A plurality of dielectric layers 111 may form the body 110. The plurality of dielectric layers 111 are in a sintered state, such that boundaries between adjacent dielectric layers 111 may be integrated so as to be difficult to identify without using a scanning electron microscope (SEM)

The raw material forming the dielectric layer 111 is not limited as long as sufficient electrostatic capacitance can be obtained. In general, perovskite ABO₃-based materials may be used, for example, barium titanate-based materials, lead composite perovskite-based materials, or strontium titanate-based materials may be used. The barium titanate-based material may include BaTiO₃-based ceramic particles, and examples of the ceramic particles include BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1), in which calcium Ca, zirconium Zr, or the like are partially dissolved.

In addition, the raw material for forming the dielectric layer 111 may be particles such as barium titanate BaTiO₃, to which various ceramic additives, organic solvents, binders, dispersants, or the like, may be added according to the purpose of the present disclosure.

Meanwhile, in order to distinguish a dielectric layer 111 from the dielectric layers included in cover portions 112 and 113 and side margin portions 114 and 115 to be described later, the dielectric layer 111 included in the capacitance forming portion Ac may be defined as a first dielectric layer, the dielectric layer included in the cover portions 112 and 113 may be defined as a second dielectric layer, and the dielectric layer included in the side margin portions 114 and 115 may be defined as a third dielectric layer.

In addition, since the first to third dielectric layers may be formed using a dielectric material such as barium titanate BaTiO₃, they may include a dielectric microstructure after sintering. The dielectric microstructure may include a plurality of grains, grain boundaries disposed between adjacent grains, and triple points disposed at points where three or more grain boundaries meet, and may each include a plurality of grains, grain boundaries, and triple points.

A thickness td of the dielectric layer 111 is not particularly limited.

In order to secure reliability of the multilayer electronic component 100 under a high-voltage environment, the thickness td of the dielectric layer 111 may be 10.0 μm or less, 9.0 μm or less, 8.0 μm or less, 7.0 μm or less, 6.0 μm or less, or 5.0 μm or less. In addition, in order to achieve miniaturization and high capacitance of the multilayer electronic component 100, the thickness td of the dielectric layer 111 may be 3.0 μm or less, 2.0 μm or less, or 1.0 μm or less, and in order to more easily achieve ultra-miniaturization and high capacitance, the thickness td of the dielectric layer 111 may be 0.6 μm or less, 0.5 μm or less, or 0.4 μm or less. In addition, in order to achieve miniaturization and high capacitance of the multilayer electronic component 100, the thickness td of the dielectric layer 111 may be 3.0 μm or less, 2.0 μm or less, or 1.0 μm or less, and in order to more easily achieve ultra-miniaturization and high capacitance, the thickness td of the dielectric layer 111 may be 0.6 μm or less, 0.5 μm or less, or 0.4 μm or less.

Here, the thickness td of the dielectric layer 111 may mean the thickness td of the dielectric layer 111 disposed between the internal electrode layer and the floating electrode layer.

In this case, the thickness td of the dielectric layer 111 may be a concept including the thickness td of any one of a plurality of dielectric layer 111 or may be a concept including the thickness td of each of all dielectric layers 111.

In addition, the thickness td of the dielectric layer 111 may mean the average thickness td of one dielectric layer 111, may mean an average thickness td of each of the plurality of dielectric layers 111, or may mean the average thickness td of the plurality of dielectric layers 111.

The average thickness td of the dielectric layer 111 may be measured by scanning an image of a cross-section in the length and thickness direction of the body 110 using a field emission scanning electron microscope (SEM) at 10,000× magnification. More specifically, the average thickness td of one dielectric layer 111 may mean an average value calculated by measuring the thickness of one dielectric layer 111 at 5 points equally spaced apart in the length direction in a scanned image. The 5 points equally spaced apart from each other may be designated in the capacitance formation portion Ac. In addition, by extending this average value measurement to 3 dielectric layers 111 and calculating the average value, the average thickness td of the plurality of dielectric layers 111 may be further generalized.

The internal electrode layer and the floating electrode layer may be alternately stacked with the dielectric layer 111.

The internal electrode layer may include the first internal electrode 121 and the second internal electrode 122 that are disposed on the dielectric layer 111 and spaced apart from each other in the length direction. The floating electrode layer may include the third internal electrode 123 disposed on the dielectric layer 111 different from the internal electrode layer (e.g., different from the internal electrodes 121 and 122). The internal electrodes 121 and 122 of the internal electrode layer and the third internal electrode 123 of the floating electrode layer may be electrically separated from each other by the dielectric layer 111 disposed in the middle.

Additionally, in the present disclosure, the body 110 may not include any internal electrodes other than the internal electrodes 121, 122 and 123.

Moreover, the structure of the internal electrodes 121, 122 and 123 included in the internal electrode layer and/or the floating electrode layer described in the present disclosure may be confirmed by observing the cross-section in the length and width directions, and equipment such as an optical microscope (OM) or the scanning electron microscope (SEM) may be used.

More specifically, the first internal electrode 121 and the second internal electrode 122 may be disposed on one dielectric layer 111 and spaced apart from each other in the length direction with a space portion (gap) therebetween. The first internal electrode 121 may be exposed through the third surface 3 while being spaced apart from the fourth surface 4, and the second internal electrode 122 may be exposed through the fourth surface 4 while being spaced apart from the third surface 3. The first external electrode 131 may be disposed on the third surface 3 of the body 110 and connected to the first internal electrode 121 exposed to the third surface 3, and the second external electrode 132 may be disposed on the fourth surface 4 of the body 110 and connected to the second internal electrode 122 exposed to the fourth surface 4.

That is, the first internal electrode 121 may be connected to the first external electrode 131 without being connected to the second external electrode 132, and the second internal electrode 122 may be connected to the second external electrode 132 without being connected to the first external electrode 131.

The first internal electrode 121 may include a first capacitance portion overlapping with the third internal electrode 123 in the thickness direction, and a first lead portion not overlapping with the third internal electrode 123 in the thickness direction and the second internal electrode 122 may include a second capacitance portion overlapping the third internal electrode 123 in the thickness direction, and a second lead portion not overlapping the third internal electrode 123 in the thickness direction.

The first and second capacitance portions and the first and second lead portions may each have a substantially constant size in the width direction.

Here, the fact that the first and second capacitance portions and the first and second lead portions each have substantially constant sizes in the width direction may mean that the sizes of each configuration in the width direction have substantially constant shapes, and more specifically, for example, may mean a rectangular shape.

In addition, an error between the size of the first capacitance portion in the width direction and the first lead portion in the width direction, based on the size of the first capacitance portion in the width direction may be ±5% or less, and an error between the size of the second capacitance portion in the width direction and the size of the second lead portion in the width direction may be ±5% or less based on the size of the second capacitance portion in the width direction.

Here, the error between the sizes of the first capacitance portion and the first lead portion in the width direction being less than ±5% based on the size of the first capacitance portion in the width direction may mean that the sizes of the first capacitance portion and the first lead portion in the width direction are substantially the same. The error between the sizes of the second capacitance portion and the second lead portion in the width direction being less than ±5% based on the size of the second capacitance portion in the width direction may mean that the sizes of the second capacitance portion and the second lead portion in the width direction are substantially the same. More specifically, for example, the first capacitance portion and the first lead portion may have a single rectangular shape, and the second capacitance portion and the second lead portion may have a single rectangular shape.

The first and second capacitance portions and the first and second lead portions each have substantially constant sizes in the width direction, by satisfying that the error between the size of the first capacitance portion and the first lead portion in the width direction, based on the size of the first capacitance portion in the width direction, is ±5% or less, and that the error between the size of the second capacitance portion and the second lead portion in the width direction based on the size of the second capacitance portion in the width direction, is ±5% or less, the desired capacitance characteristics may be achieved by securing sufficient overlapping area between the internal electrode layer and the internal electrode of the floating electrode layer. More specifically, for example, the dielectric capacitance value of the multilayer electronic component 100 applicable to a high-voltage environment by the structure may be maintained at 100 nF or more, preferably 105 nF or more, or the dissipation factor DF value may be maintained at 0.7% or less, preferably 0.65% or less.

The third internal electrode 123 may be disposed on a dielectric layer 111 different from the dielectric layer 111 of the internal electrode layer, may be spaced apart from the external electrodes 131 and 132, and, more specifically, may be spaced apart from the third to sixth surfaces 3, 4, 5 and 6.

The third internal electrode 123 may include the main portion 123a overlapping with the internal electrodes 121 and 122 in the thickness direction, and the connection portion 123b not overlapping with the internal electrodes 121 and 122 in the thickness direction.

More specifically, the main portion 123a may include a first main portion 123a-1 overlapping with the first capacitance portion of the first internal electrode 121 in the thickness direction, and a second main portion 123a-2 overlapping with the second capacitance portion of the second internal electrode 122 in the thickness direction. The first main portion 123a-1 may not overlap with the first lead portion of the first internal electrode 121 in the thickness direction, and the second main portion 123a-2 may not overlap with the second lead portion of the second internal electrode 122 in the thickness direction.

In the present disclosure, unless otherwise specifically contradictory, the description of the main portion 123a may correspond to the description of each of the first main portion 123a-1 and the second main part 123a-2.

The main portion 123a and the connection portion 123b may each have a substantially constant size in the width direction.

Here, the fact that the main portion 123a and the connection portion 123b each have a substantially constant size in the width direction may mean that the size of each component in the width direction has a substantially constant shape, and more specifically, for example, it may mean a square shape.

In addition, the connection portion 123b may overlap with the space portion (gap) of a region where the internal electrodes 121 and 122 are spaced apart in the thickness direction, and the error between the size of the connection portion 123b and the space portion in the length direction may be 5% or less based on the size (FCL) of the connection portion 123b in the length direction.

Here, an error of the size of the connection portion 123b and the space portion (gap) in the length direction is ±5% or less, based on the size (FCL) of the connection portion 123b in the length direction, which may mean that the sizes of the connection portion 123b and the space portion (gap) in the width direction may be substantially the same, and this may mean that the separated size between the first and second capacitance portions in the length direction and the separated size between the first and second main portions 123a-1 and 123a-2 in the length direction may be substantially the same.

By satisfying that the error between the size of the connection portion 123b and the space portion (gap) in the length direction is ±5% or less based on the size (FCL) of the connection portion 123b in the length direction, the capacitance characteristics may be improved while also improving the breakdown voltage (BDV) characteristics.

In the present disclosure, a ratio (FCW/FMW) of the size (FCW) of the connection portion 123b in the width direction to the size (FMW) of the main portion 123a in the width direction may satisfy 1/4≤FCW/FMW≤1/2.

By satisfying the ratio (FCW/FMW) of the size (FCW) of the connection portion 123b in the width direction to the size (FMW) of the main portion 123a in the width direction of 1/4≤FCW/FMW≤1/2, the breakdown voltage (BDV) characteristics may be improved by improving the resistance to electrostriction expansion in the thickness direction that may occur when high-voltage is applied.

If the ratio (FCW/FMW) of the size (FCW) of the connection portion 123b in the width direction to the size (FMW) of the main portion 123a in the width direction is less than 1/4, there may be a concern that the connectivity between the first and second main portions 123a-1 and 123a-2 may be reduced, resulting in a reduction in the capacitance characteristics, and if the ratio (FCW/FMW) of the size (FCW) of the connection portion 123b in the width direction to the size (FMW) of the main portion 123a in the width direction exceeds 1/2, the electrode area under a high-voltage environment may be excessive, and the effect of improving the breakdown voltage (BDV) may not be sufficient.

In this case, the connection portion 123b may be disposed in the center relative to the main portion 123a in the width direction.

Here, the connection portion 123b being disposed closer to the central portion in the width direction than the main portion 123a may mean that both sides of the connection portion 123b in the width direction have a grooved or cut-shape based on the shape of the main portion 123a.

Meanwhile, the body 110 may be formed by alternately laminating a first ceramic green sheet printed with a paste for a first internal electrode 121 and a paste for a second internal electrode 122 with a second ceramic green sheet printed with a paste for a third internal electrode 123, and then firing the laminated sheets. The printing method of the conductive paste for the internal electrode may use a screen-printing method or a gravure printing method, but the present invention is not limited thereto.

The material forming the internal electrodes 121, 122 and 123 is not particularly limited, and a material with excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti) and alloys thereof.

Meanwhile, a thickness te of the internal electrodes 121, 122 and 123 are not particularly limited, and the description of the thickness te of the internal electrodes 121, 122 and 123 below may mean the thickness te of the first internal electrode 121, the second internal electrode 122, and the third internal electrode 123, respectively.

Meanwhile, in order to secure reliability of the multilayer electronic component 100 under a high-voltage environment, the thickness te of the internal electrodes 121, 122 and 123 may be 3.0 μm or less. Additionally, in order to achieve miniaturization and high capacitance of the multilayer electronic component 100, the thickness te of the internal electrodes 121, 122 and 123 may be 1.0 μm or less. In order to more easily achieve miniaturization and high capacitance, the thickness te of the internal electrodes 121, 122 and 123 may be 0.6 μm or less, and more preferably 0.4 μm or less.

In this case, the thickness te of the internal electrode 121, 122 and 123 may be a concept including the thickness te of at least one of the plurality of internal electrodes 121, 122 and 123, or may be a concept including the thickness te of the plurality of internal electrodes 121, 122 and 123, respectively.

In addition, the thickness te of the internal electrode 121 and 122 may mean the average thickness te of one internal electrode (121, 122, 123), or may mean the average thickness te of the plurality of internal electrodes 121, 122 and 123, respectively or may mean the average thickness te of the plurality of internal electrodes 121, 122 and 123.

The average thickness te of the internal electrodes 121, 122 and 123 may be measured by scanning an image of a cross-section of the body 110 in the length and thickness direction using a scanning electron microscope (SEM) at 10,000× magnification. More specifically, the average thickness te of one internal electrodes 121, 122 and 123 may be an average value calculated by measuring the thickness of one internal electrode at 5 points equally spaced apart in the length direction in the scanned image. The 5 points equally spaced apart may be designated in the capacitance formation portion Ac.

Meanwhile, in an embodiment of the present disclosure, the thickness td of at least one of the plurality of dielectric layers 111 and the thickness te of at least one of the plurality of internal electrodes 121, 122 and 123 may satisfy 2×te<td.

In other words, the thickness td of one dielectric layer 111 may be greater than twice the thickness te of one internal electrode 121, 122 and 123. Preferably, the average thickness td of the plurality of dielectric layers 111 may be greater than twice the average thickness te of the plurality of internal electrodes 121, 122 and 123.

In general, the main issue for high-voltage electronic components is reliability problems due to the decrease in breakdown voltage (BDV) under high-voltage environments.

Accordingly, in order to prevent a decrease in the breakdown voltage under the high-voltage environment, the breakdown voltage characteristics may be improved by making the average thickness td of the dielectric layer 111 greater than twice the average thickness te of the internal electrodes 121, 122 and 123.

When the average thickness td of the dielectric layer 111 is equal or less than twice the average thickness te of the internal electrodes 121, 122 and 123, the insulation breakdown voltage may decrease and a short circuit may occur between the internal electrodes.

Meanwhile, in an embodiment of the present disclosure, the thickness td of at least one of the plurality of dielectric layers 111 and the thickness te of at least one of the plurality of internal electrodes 121 and 122 may satisfy 2×te<td.

In other words, the thickness td of one dielectric layer 111 may be greater than twice the thickness te of one internal electrodes 121 and 122. Preferably, the average thickness td of the plurality of dielectric layers 111 may be greater than twice the average thickness te of the plurality of internal electrodes 121 and 122.

In general, the main issue for high-voltage electronic components is reliability problems due to the decrease in breakdown voltage (BDV) under high-voltage environments.

Accordingly, in order to prevent a decrease in the breakdown voltage under a high-voltage environment, the breakdown voltage characteristics may be improved by making the average thickness td of the dielectric layer 111 greater than twice the average thickness te of the internal electrodes 121 and 122.

When the average thickness td of the dielectric layer 111 is less than twice the average thickness te of the internal electrodes 121 and 122, the breakdown voltage may decrease and a short circuit may occur between the internal electrodes.

Meanwhile, the body 110 may include cover portions 112 and 113 disposed on both end-surfaces of the capacitance formation portion Ac in the thickness direction.

Specifically, the body 110 may include a first cover portion 112 disposed on one surface of the capacitance formation portion Ac in the thickness direction and a second cover portion 113 disposed on the other surface of the capacitance formation portion Ac in the thickness direction. More specifically, for example, it may include a first cover portion 112 disposed lower portion of the capacitance formation portion Ac in the thickness direction and a second cover portion 113 disposed upper portion of the capacitance formation portion Ac in the thickness direction.

The first cover portion 112 and the second cover portion 113 may be formed by disposing or laminating a single second dielectric layer or two or more second dielectric layers on the upper and lower surfaces of the capacitance formation portion Ac respectively, in the thickness direction. The first cover portion 112 and the second cover portion 113 may basically contribute to preventing damage to the internal electrodes 121 and 122 due to physical or chemical stress.

The first cover portion 112 and the second cover portion 113 may not include internal electrodes 121 and 122, and may include the same dielectric material as the dielectric layer 111 of the capacitance formation portion Ac. That is, the first cover portion 112 and the second cover portion 113 may include a dielectric material, for example, a barium titanate (BaTiO₃)-based dielectric material.

Meanwhile, the thickness tc of the cover portions 112 and 113 are not particularly limited, and the description of the thickness tc of the cover portions 112 and 113 below may mean the thickness tc of each of the first cover portion 112 and the second cover portion 113.

However, in order to maintain reliability of the multilayer electronic component 100 under a high-voltage environment, the thickness tc of the cover portions 112 and 113 may be 1200 μm or less, 1100 μm or less, 1000 μm or less, 900 μm or less, 800 μm or less, 700 μm or less, 600 μm or less, 500 μm or less, 400 μm or less, 300 μm or less, 200 μm or less, or 100 μm. In order to more easily achieve miniaturization and high capacitance of the multilayer electronic component 100, the thickness tc of the cover portions 112 and 113 may be 80 μm or less or 50 μm or less, preferably 30 μm or less, and in ultra-small products, more preferably 20 μm or less.

Here, the thickness tc of the cover portions 112 and 113 may mean the average thickness of the cover portions 112 and 113.

Additionally, the average thickness tc of the cover portions 112 and 113 may mean the average thickness tc of each of the first and second cover portions 112 and 113 or may mean the average thickness tc of the first and second cover portions 112 and 113.

The average thickness tc of the cover portions 112 and 113 may be measured by scanning an image of a cross-section of the body 110 in the length and thickness direction using a scanning electron microscope (SEM) at 10,000× magnification. More specifically, it may mean an average value calculated by measuring the thickness at 5 points equally spaced apart in the length direction in an image scanned of one cover portions 112 and 113.

In addition, the average thickness tc of the cover portions 112 and 113 measured by the above-described method may have a value substantially the same as the average thickness of the cover portions 112 and 113 in the cross-section of the body 110 in the width and thickness direction.

Meanwhile, the multilayer electronic component 100 may include a side margin portions 114 and 115, which is an end region of the internal electrodes 121 and 122 in the width direction.

More specifically, the side margin portions 114 and 115 may include a first side margin portion 114 and a second side margin portion 115. The first side margin portion 114 may be disposed between the internal electrodes 121 and 122, and the fifth surface 5. The second side margin portion 115 may disposed between the internal electrodes 121 and 122, and the sixth surface 6.

As illustrated, the side margin portions 114 and 115 may refer to a region between the ends of the internal electrodes 121 and 122 in the width direction and the boundary surface of the body 110, based on the cross-section of the body 110 in the width and thickness directions.

The side margin portions 114 and 115 may refer to a ceramic green sheet region excluding the internal electrodes 121 and 122 when the internal electrode paste is applied onto the ceramic green sheet for the capacitance formation portion Ac, excluding regions corresponding to the side margin portions 114 and 115.

However, it is not particularly limited thereto, and the side margin portions 114 and 115 may be formed by applying a conductive paste to the ceramic green sheet applied to the capacitance formation portion Ac, other than the region in which the side margin portions 114 and 115 may be formed, thereby forming internal electrodes 121 and 122, and in order to suppress a step difference caused by the internal electrodes 121 and 122, the body 110 may be cut so that the internal electrodes 121 and 122 after stacking to be exposed to the fifth and sixth surfaces 5 and 6 of the body 110, and then a single third dielectric layer or two or more third dielectric layers may be formed by disposing or stacking them on both end-surfaces of the capacitance formation portion Ac in the width direction.

The side margin portions 114 and 115 may basically contribute to prevent damage to the internal electrodes 121 and 122 due to physical or chemical stress.

The side margin portions 114 and 115 do not include internal electrodes 121 and 122. The side margin portions 114 and 115 may include the same material as the dielectric layer 111, and may correspond to, for example, a portion of the dielectric layer 111. That is, the side margin portions 114 and 115 may include a dielectric material, for example, a barium titanate (BaTiO₃)-based dielectric material.

Meanwhile, a width wm of the side margin portions 114 and 115 may not need to be particularly limited, and the description of the width wm of the side margin portions 114 and 115 may mean a width wm of the first side margin portion 114 and the second side margin portion 115, respectively.

In order to easily implement miniaturization and high capacitance of the multilayer electronic component 100, the width wm of the side margin portions 114 and 115 may be 50 μm or less, preferably 30 μm or less, and may be more preferably 20 μm or less in ultra-small products.

Here, the width wm of the side margin portions 114 and 115 may mean an average width wm of the side margin portions 114 and 115.

Additionally, the average width wm of the side margin portions 114 and 115 may mean the average width wm of each of the first side margin portions 114 and the second side margin portions 115, or may mean an average width wm of the side margin portions 114 and 115 collectively.

The average width wm of the side margin portions 114 and 115 may be measured by scanning an image of a cross-section of the body 110 in the width and thickness direction using a scanning electron microscope (SEM) at 10,000× magnification. More specifically, it may mean an average value calculated by measuring the width at 5 points equally spaced apart in the thickness direction in an image scanned of one side margin portions 114 and 115.

In the present disclosure, the multilayer electronic component 100 may not include any external electrodes other than the external electrodes 131 and 132.

More specifically, the external electrodes 131 and 132 may be disposed on the third and fourth surfaces 3 and 4 of the body 110, respectively, and may include first and second external electrodes 131 and 132 connected to the internal electrodes 121 and 122, respectively. That is, the first external electrode 131 may be disposed on the third surface 3 of the body and may be connected to the first internal electrode 121 exposed to the third surface 3, and the second external electrode 132 is disposed on the fourth surface 4 of the body and may be connected to the second internal electrode 122 exposed to the fourth surface 4. Additionally, the external electrodes 131 and 132 may not be connected to the third internal electrode 123.

Additionally, the external electrodes 131 and 132 may extend and be disposed on portions of the first and second surfaces 1 and 2 of the body 110 or may extend and be disposed on portions of the fifth and sixth surfaces 5 and 6 of the body 110. That is, the first external electrode 131 may be disposed on the third surface 3 of the body 110 and a portion of the first, second, fifth, and sixth surfaces 1, 2, 5, and 6 of the body 110, and the second external electrode 132 may be disposed on the fourth surface 4 of the body 110 and a portion of the first, second, fifth, and sixth surfaces 1, 2, 5, and 6 of the body 110.

The external electrodes 131 and 132 may be formed of any material having electrical conductivity, such as metal, and a specific material may be determined in consideration of electrical characteristics and structural stability, or the like, and may include an electrode layer. Furthermore, the electrode layer may have a multilayer structure.

For example, the external electrodes 131 and 132 may include first electrode layers 131a and 131b disposed on the body 110, and second electrode layers 131b and 132b disposed on the first electrode layers 131a and 132a. Furthermore, it may include third electrode layers 131c and 132c disposed on the second electrode layers 131b and 132b.

Here, it may be desirable for the electrode layers 131a, 132a, 131b, 132b, 131c, 132c to correspond to distinct layers. However, it is not particularly limited to this and may be distinguished according to the order of the manufacturing process, and at least some of the layers among the electrode layers 131a, 132a, 131b, 132b, 131c, 132c may not be distinguished from each other and may be observed as one layer.

In the present disclosure, the term “distinguished” may mean that two layers are distinguished due to physical differences, chemical differences, and/or simple optical differences, and is not particularly limited thereto, but the distinction between layers may be identified by the presence or absence of an “interface.” The term “interface” may mean a surface where two layers in contact with each other are distinguishable from each other and may mean a state where they can be distinguished by differences in components, such as through EDS analysis using equipment such as a scanning electron microscope (SEM).

The first electrode layers 131a and 132a, and the second electrode layers 131b and 132b may be formed by transferring a sheet including a conductive metal onto the body 110, or may be formed by applying a conductive paste for an external electrode including a conductive metal to the body 110 and then performing sintering, or may be formed by dipping the body 110 into a conductive paste for an external electrode including a conductive metal, but are not particularly limited thereto.

More specifically, the external electrodes 131 and 132 may include the first electrode layers 131a and 132a disposed on the body 110 and including a first conductive metal and glass, and the second electrode layers 131b and 132b including a second conductive metal and resin disposed on the first electrode layers 131a and 132a.

A material having excellent electrical conductivity may be used as the conductive metal included in the electrode layers 131a, 132a, 131b and 132b, and for example, the conductive metal may include one or more selected from a group consisting of nickel (Ni), copper (Cu), palladium (Pd), silver (Ag), gold (Au), platinum (Pt), tin (Sn), tungsten (W), titanium (Ti) and alloys thereof, but is not particularly limited thereto.

Here, the conductive metal included in the first electrode layers 131a and 132a may be referred to as the first conductive metal, and the conductive metal included in the second electrode layers 131b and 132b may be referred to as the second conductive metal. In this case, the first conductive metal and the second conductive metal may be the same or different from each other, and when a plurality of conductive metals are included, only a portion of them may include the same conductive metal, but this is not particularly limited thereto.

The glass included in the first electrode layers 131a and 132a may improve bonding with the body 110 and is not particularly limited as long as it may improve bonding with the body 110. The resin included in the second electrode layers 131b and 132b may contribute to improve flexural strength and is not particularly limited as long as it can be mixed with the second conductive metal to form a paste, and may include, for example, an epoxy resin.

The first conductive metal included in the first electrode layers 131a and 132a may be configured to electrically connect with the internal electrodes 121 and 122.

The first conductive metal included in the first electrode layers 131a and 132a is not particularly limited as long as it is a material that can be electrically connected to the internal electrodes 121 and 122, and may include, for example, at least one of nickel (Ni), copper (Cu), palladium (Pd), silver (Ag), gold (Au), platinum (Pt), tin (Sn), tungsten (W), titanium (Ti), and alloys thereof.

The second conductive metal included in the second electrode layers 131b and 132b may configured to electrically connect with the first electrode layers 131a and 132a.

The second conductive metal included in the second electrode layers 131b and 132b is not particularly limited as long as it is a material that can be electrically connected to the first electrode layers 131a and 132a, and may include at least one of nickel (Ni), copper (Cu), palladium (Pd), silver (Ag), gold (Au), platinum (Pt), tin (Sn), tungsten (W), titanium (Ti), and alloys thereof.

The second conductive metal included in the second electrode layers 131b and 132b may include at least one of spherical particles and flake-shaped particles. That is, the second conductive metal may be composed solely of flake-shaped particles, solely of spherical particles, or may be a mixture of flake-shaped particles and spherical particles.

Here, the spherical particles may also include shapes that are not perfectly spherical, for example, shapes having a dimensional ratio in the major axis to minor axis direction (major axis/minor axis) of 1.45 or less. Flake-shaped particles refer to particles having a flat and elongated shape, and are not particularly limited, but for example, the dimensional ratio in the long axis and short axis directions (long axis/short axis) may be 1.95 or more. The dimensions of the spherical particles and flake-shaped particles in the major and minor axis directions may be measured from images obtained by scanning a cross-section in the length and thickness directions cut from the center of the width direction of the multilayer electronic component using a scanning electron microscope (SEM).

Additionally, the second electrode layers 131b and 132b may include an intermetallic compound.

By including an intermetallic compound, electrical connectivity with the first electrode layers 131a and 132a may be further improved. The intermetallic compound configures to improve electrical connectivity by connecting a plurality of second conductive metal particles and may configure to surround and connect the plurality of second conductive metal particles to each other.

At this time, the intermetallic compound may include a metal having a melting point lower than the curing temperature of the resin. That is, because the intermetallic compound contains a metal with a melting point lower than the curing temperature of the resin, the metal having a melting point lower than the curing temperature of the resin melts during the drying and curing process, forms an intermetallic compound with a portion of the metal particles, and surrounds the metal particles. At this time, the intermetallic compound may preferably include a low melting point metal of 300° C. or less. More specifically, it may include tin (Sn) having a melting point of 213 to 220° C. During the drying and hardening process, tin (Sn) is melted, and the molten tin (Sn) wets high-melting-point metal particles such as silver (Ag), nickel (Ni), or copper (Cu) by capillary action. The molten tin (Sn) may react with a portion of the silver (Ag), nickel (Ni), or copper (Cu) metal particles to form intermetallic compounds such as Ag₃Sn, Ni₃Sn₄, Cu₆Sn₅, and Cu₃Sn. Silver (Ag), nickel (Ni), or copper (Cu) that did not participate in the reaction may remain in the form of metal particles.

Accordingly, the plurality of second conductive metal particles may include at least one of silver (Ag), nickel (Ni), and copper (Cu), and the intermetallic compound may include one or more of Ag₃Sn, Ni₃Sn₄, Cu₆Sn₅, and Cu₃Sn.

The third electrode layers 131c and 132c may contribute to improve the mounting characteristics and may be a plating layer formed on the second electrode layers 131b and 132b by plating, but are not particularly limited thereto.

The type of the third electrode layers 131c and 132c is not particularly limited, and may include, for example, at least one of nickel (Ni), tin (Sn), silver (Ag), palladium (Pd), and alloys thereof.

The third electrode layers 131c and 132c may be a single layer or may be multiple layers.

More specifically, for example, the third electrode layers 131c and 132c may be a nickel (Ni) electrode layer or a tin (Sn) electrode layer, and may be in the form of a nickel (Ni) electrode layer and a tin (Sn) electrode layer sequentially formed on the second electrode layers 131b and 132b, or may be in the form of a tin (Sn) electrode layer, a nickel (Ni) electrode layer, and a tin (Sn) electrode layer sequentially formed. In addition, the third electrode layers 131c and 132c may include a plurality of nickel (Ni) electrode layers and/or a plurality of tin (Sn) electrode layers.

There is no need to specifically limit the size of the multilayer electronic component 100.

However, in order to maintain reliability under a high-voltage environment, the thickness of the cover portion, dielectric layer and/or internal electrode must be increased, so the effect according to the present disclosure may be more noticeable in a multilayer electronic component 100 having a size of 2012 (length×width: 2.0 mm×1.2 mm, length and width satisfy an error of 10%) or greater.

The multilayer electronic component 100 according to an embodiment of the present disclosure has been described mainly in the case where the length is greater than the width, but in contrast, the multilayer electronic component 100 according to another embodiment of the present disclosure may have a width greater than the length.

Hereinafter, the present disclosure will be described in more detail through test examples, but this is only to help a specific understanding of the disclosure, and the scope of the present disclosure is not limited by the test examples.

### Exam Example

[Table 1] below illustrates the average and maximum values of dielectric capacitance (C), dielectric loss factor (DF), and breakdown voltage (BDV) of comparative examples and examples having different structures of floating electrode layers.

In the comparative example, a sample chip was fabricated to include a body in which an internal electrode layer including first and second internal electrodes and a floating electrode layer including a floating electrode are alternately laminated with a dielectric layer interposed therebetween, and first and second external electrodes disposed on the body. The floating electrode of the comparative example has a constant width and a square-shaped structure.

The inventive example fabricated a sample chip in the same manner as the comparative example, except that it had a floating electrode layer including a third internal electrode 123. The third internal electrode 123 was manufactured so that a size of the connection portion 123b in the width direction was ⅓ of the size of the main portion 123a in the width direction.

The average breakdown voltage (kV) is calculated and recorded as the average value of sample chips in which a defect occurred during the breakdown evaluation, and the maximum breakdown voltage (kV) is recorded as the maximum value among the sample chips in which breakdown occurred.

TABLE 1

| | | Dielectric | Average | Maximum |
|---|---|---|---|---|
| | Dielectric | Loss | Breakdown | Breakdown |
| | Capacitance | Tangency | Voltage | Voltage |
| | (nF) | (%) | (kV) | (kV) |
| Comparative | 109.73 nF | 0.66% | 2.88 kV | 3.87 kV |
| example | | | | |
| Inventive | 109.73 nF | 0.65% | 3.39 kV | 4.46 kV |
| example | | | | |

It may be confirmed that the dielectric capacitance (nF) and the dielectric loss tangency (%) are almost identical between the comparative example and the inventive example, but the average breakdown voltage (kV) of the inventive example increased by about 17.7% compared to the average breakdown voltage (kV) of the comparative example, and the maximum breakdown voltage (kV) of the inventive example increased by about 15.2% compared to the maximum breakdown voltage (kV) of the comparative example.

From this, in the third internal electrode structure of the floating electrode layer, when the ratio (FCW/FMW) of the size (FCW) of the connection portion in the width direction to the size (FMW) of the main portion in the width direction satisfies 1/4≤FCW/FMW≤1/2, it may be confirmed that the dielectric capacitance and/or dielectric loss tangency characteristics are not deteriorated, while the breakdown voltage characteristics are improved.

Although the embodiments or test examples of the present disclosure have been described in detail above, the present disclosure is not limited by the above-described embodiments and the accompanying drawings and is intended to be limited by the appended claims. Therefore, various forms of substitution, modification, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment and are not intended to limit the disclosure. In this case, singular expressions include plural expressions unless the context clearly indicates otherwise.

While the embodiments have been illustrated and described above, it will be configured as apparent to those skilled in the art that modifications and variations could be made without departing from the scope of the present disclosure as defined by the appended claims.

What is claimed is:

1. A multilayer electronic component comprising:
a body including:
a capacitance formation portion including:
a dielectric layer, and
an internal electrode layer and a floating electrode layer alternately disposed in a thickness direction with the dielectric layer interposed therebetween,
first and second surfaces facing each other in the thickness direction,
third and fourth surfaces connected to the first and second surfaces and facing each other in a length direction, and
fifth and sixth surfaces connected to the first to fourth surfaces and facing each other in a width direction; and
first and second external electrodes respectively disposed on the third and fourth surfaces,
wherein the internal electrode layer includes
a first internal electrode exposed to the third surface and connected to the first external electrode, and
a second internal electrode spaced apart from the first internal electrode and exposed to the fourth surface and connected to the second external electrode,
wherein the floating electrode layer includes a third internal electrode spaced apart from the first and second external electrodes, and the third internal electrode includes a main portion overlapping the first and second internal electrodes in the thickness direction, and a connecting portion not overlapping the first and second internal electrodes in the thickness direction,
wherein a ratio (FCW/FMW) of a size (FCW) of the connecting portion in the width direction to a size (FMW) of the main portion in the width direction, satisfies 1/4≤FCW/FMW≤1/2.

2. The multilayer electronic component of claim 1, wherein the multilayer electronic component does not include any external electrodes other than the first and second external electrodes.

3. The multilayer electronic component of claim 1, wherein the body does not include any internal electrodes other than the first to third internal electrodes.

4. The multilayer electronic component of claim 1, wherein the first to third internal electrodes are spaced apart between the fifth and sixth surfaces.

5. The multilayer electronic component of claim 1, wherein the first internal electrode includes a first capacitance portion overlapping the third internal electrode in the thickness direction, and a first lead portion not overlapping the third internal electrode in the thickness direction,
wherein the second internal electrode includes a second capacitance portion overlapping the third internal electrode in the thickness direction, and a second lead portion not overlapping the third internal electrode in the thickness direction,
wherein the first and second capacitance portions, the first and second lead portions, the main portion and the connection portion each have substantially constant sizes in the width direction, and
wherein an error between the size of the first capacitance portion and the first lead portion in the width direction is ±5% or less based on the size of the first capacitance portion in the width direction, and an error between the size of the second capacitance portion and the second lead portion in the width direction is ±5% or less based on the size of the second capacitance portion in the width direction.

6. The multilayer electronic component of claim 1, wherein a region where the first and second internal electrodes are spaced apart in the internal electrode layer defines a space portion, and
wherein the connecting portion overlaps the space portion in the thickness direction.

7. The multilayer electronic component of claim 6, wherein an error in a size of the connecting portion and the space portion in the length direction based on the size of the connecting portion in the length direction is ±5% or less.

8. The multilayer electronic component of claim 1, wherein, in the floating electrode layer, the connecting portion is disposed in a central portion in the width direction relative to the main portion.

9. The multilayer electronic component of claim 1, wherein a length of the multilayer electronic component is 2.0 mm or more and the width is 1.2 mm or more.
